(19) United States
(12) Patent Application Publication
(10) Pub. No.: US 2007/0130063 A1
(43) Pub. Date: Jun. 7, 2007

(54) Method for paperless generation of electronic negotiable instruments

(76) Inventors: Ajay Kumar Jindia, Smyrna, GA (US); Lisa M. DeCaprio, Dacula, GA (US)

Correspondence Address: PHILIP H. BURRUS, IV, 460 Grant Street, Atlanta, GA, 30312, US

(21) Appl. No.: 11/291,308

(22) Filed: Dec. 1, 2005

(51) Int. Cl. G06Q 40/00

(52) U.S. Cl. 705/39

(57) ABSTRACT

A method for accomplishing a paperless financial transaction is provided. The method, which may include the extension of credit, begins when a user submits data initiating and authorizing the financial transaction. From this data or a subset thereof, an electronically created check file or a combination of an electronically created check file and electronically created negotiable instrument image file are generated and are delivered for forward collection. Where credit is needed, two electronically created check files are generated—one to pay a merchant or creditor of the user, and the other, which may be held for a predetermined amount of time, to repay the entity extending credit. In either case, the transaction can be accomplished without the need of an original document.

### BACKGROUND

1. Technical Field

This invention relates generally to the transfer of electronic funds, and more particularly to an automated system and method for checkless check transaction, including an extension of credit where appropriate.

2. Background Art

As viewed by many people, banking and financial services have not changed for many years. They make deposits, write checks, keep a savings book and maybe even have a safe deposit box. Checks today look like the checks of yesterday. Deposit slips are just like the deposit slips of old. Banking would appear to be a business that operates today as it did a hundred years ago.

As anyone who is involved in the back office of a bank or financial institution can tell you, however, nothing could be farther from the truth. Financial institutions are rapidly moving into the technology age with electronic banking, electronic fund transfer and new financial vehicles. While business used to be conducted with a ledger and a pencil, computers are now used to expedite processing and reduce costs.

Take, for example, what happens to a check when written. In the old days, a person would write a check and mail or hand it to a merchant. The merchant would then deposit the check in his bank. The merchant's bank would then route the check through a clearing channel, like one of the Federal Reserve banks for example, to the person's bank for payment. This involved the check being packaged, handed to a courier, flown to the clearing bank, being packaged again, handed to another courier, flown to the person's bank, and finally being mailed to the person as a canceled check.

On Oct. 28, 2004, all of this changed. On that date, a new piece of legislation entitled the “Check Processing Act for the 21^{st} Century”, or “Check 21”, went into effect. Perhaps the biggest change that occurred as a result of this legislation was the way checks are processed. The legislation permitted the creation of an electronic check presentment by allowing a financial institution to scan an original check, thereby creating an image of the original check. When printed in conformance with the Check 21 guidelines, this image file becomes a “substitute check”, which is in effect a scanned, printed, electronic copy of the original check. The substitute check is a true negotiable instrument and can be used in the same way as an original check. Recall from the preceding paragraph that there was previously a lot of manual transportation involved in processing a check. To process a check under Check 21, the merchant's bank simply makes an electronic, scanned copy of the check and routs that electronic image across a data network through the clearing channel. They need not physically transfer the check itself. The result is lower cost processing and quicker person-to-merchant fund transfer.

While Check 21 helps the merchant both reduce costs and increase cash flow, it does not do as much for the consumer. Substitute checks still need to be made from scanned images of the original document. Accordingly, the consumer still must carry around a checkbook, write paper checks and deliver them to the merchant or creditor. This is cumbersome and time consuming.

To further compound matters, consumers must be more careful in the timing of check writing as the electronic processing has expedited the withdrawal of funds from the consumer's account. With the ever-increasing energy and living costs of today, more and more people struggle to make ends meet. Prior to Check 21, some people, who may have a paycheck coming on Friday, might try the ill-advised practice of “stretching the float” by writing post-dated checks to creditors on Wednesday. Due to the courier lag, the Wednesday check often would not clear until after Friday, when the wage funds were safely in the account. Today, however, the funds may be withdrawn within hours. Consequently, people must wait until the proper time to write checks, thereby sometimes falling into delinquency with creditors.

There is thus a need for an improved method of transferring funds that is simpler and more convenient for the customer.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 illustrates one embodiment of a method for accomplishing a financial transaction without paper in accordance with the invention.

FIG. 2 illustrates one embodiment of a blank electronically created check file in accordance with the invention.

FIG. 3 illustrates one embodiment of an electronically created check file in accordance with the invention.

FIG. 4 illustrates one embodiment of a substitute check in accordance with the invention.

FIG. 5 illustrates one embodiment of a method for accomplishing a financial transaction without paper, including the extension of credit, in accordance with the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION OF THE INVENTION

Before describing in detail embodiments that are in accordance with the present invention, it should be observed that the embodiments reside primarily in combinations of method steps and apparatus components related to a paperless electronic fund transfer and credit extension system. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

It will be appreciated that embodiments of the invention described herein may be comprised of one or more conventional processors and unique stored program instructions that control the one or more processors to implement, in conjunction with certain non-processor circuits, some, most, or all of the functions of electronic fund transfer and credit extension as described herein. The non-processor circuits may include, but are not limited to, memory devices, database systems and electronic data communication. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and integrated circuits (ICs) with minimal experimentation.

Embodiments of the invention are now described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.”

The system described herein provides a method, system and infrastructure for a person to transfer funds from a personal account, like a checking account for example, to another party, such as a merchant or creditor. The person may accomplish this transfer completely paperlessly, without the need for a paper check or other original document. Further, authorization for such a transfer may take place at, for example, a merchant when the person is purchasing goods or services. Alternately, the authorization and transfer may be initiated and approved in the comfort of the person's home by way of a computer and associated network. As such, the person may pay merchants and creditors without ever going out of the house. Additionally, when reserve funds are running low, the person may deliver fund transfers to creditors by accepting an extension of credit.

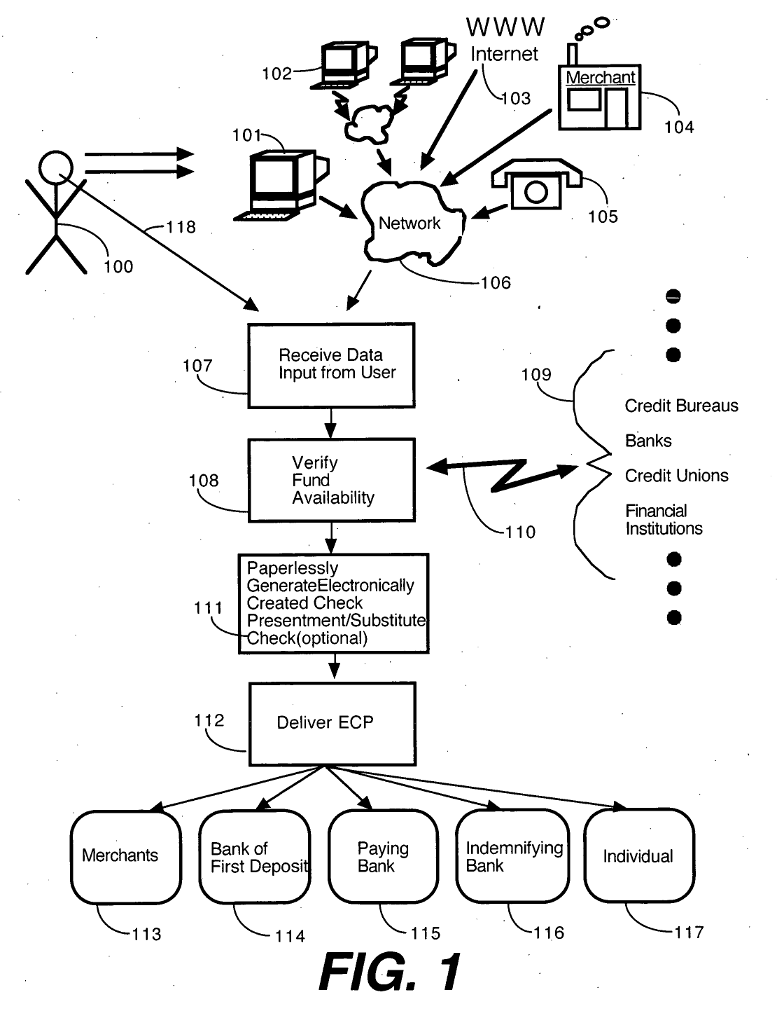

Turning now to FIG. 1, illustrated therein is one embodiment of a method for accomplishing an electronic transfer of monetary funds in accordance with the invention. The embodiment of FIG. I may be used when a user has sufficient funds in his account to cover the impending transfer. Alternate methods of the invention, including methods involving the concurrent extension of credit, will be discussed later.

As noted above, the conventional method of initiating a transfer of funds from one party to the other occurs when the first party writes a paper check. This check is delivered to the second party, who deposits it with their bank. Under Check 21, that bank then creates a substitute check for processing by scanning the original paper document (either returning it to the signor at a later date or storing it), printing it and then routing the substitute check through a clearing channel.

In the embodiment of FIG. 1, the user 100 need not write the original check. Instead, the user 100 provides sufficient data input into the system to initiate the fund transfer, perhaps by way of remote authorization. In one embodiment, this input may include (but is not limited to) the person's name, address, phone number, bank name, ABA bank routing number, bank account number, amount of funds to be transferred, next check number, party to whom the funds will be transferred, social security number and information, tax identification numbers and combinations thereof.

The system, and thus the purveyor of the system, be it a bank, merchant, credit lender or other financial institution, first receives this input from the user 100 at step 107. Note that the input may be received from a variety of sources. The input may be received from oral communications 118, perhaps in person at a merchant store or financial institution. Alternately, the user 100 may input data for transmission into a computer 101. The data input may also be received from a computer network 102, the Internet or World Wide Web 103, from a merchant 104 or via telephone 105. When data is received from such a source, it generally passes through a network 106 like telephone lines, data networks, wireless networks or other transmission systems.

Once the data has been received at step 107, the system may elect to verify that a one-time consent has been received based upon the input from the user 100 at step 108. To complete such a transaction, the user 100 may have completed an application or otherwise given approval for multiple electronic transactions to be made from his account. This one-time, multi-transaction consent is known as a “one-time consent”. This one-time consent verification may occur via electronic communication 110 with a variety of sources 109, including clearing houses, banks, a local database, database services, and other intermediaries. For example, a merchant may have received the one-time consent and may have it stored in a local computer database. As such a multi-transaction consent may be required to complete the transaction, the merchant may verify with the local computer database that such a one-time consent has been obtained.

Once this step has been completed, the system initiates a financial transfer. This may be done in a variety of ways. In two embodiments described herein, an electronically created check file is generated. In one embodiment, in addition to the electronically created check file, an electronically created negotiable instrument image file is generated for either processing or record keeping. Generation of the electronically created check file will be discussed first.

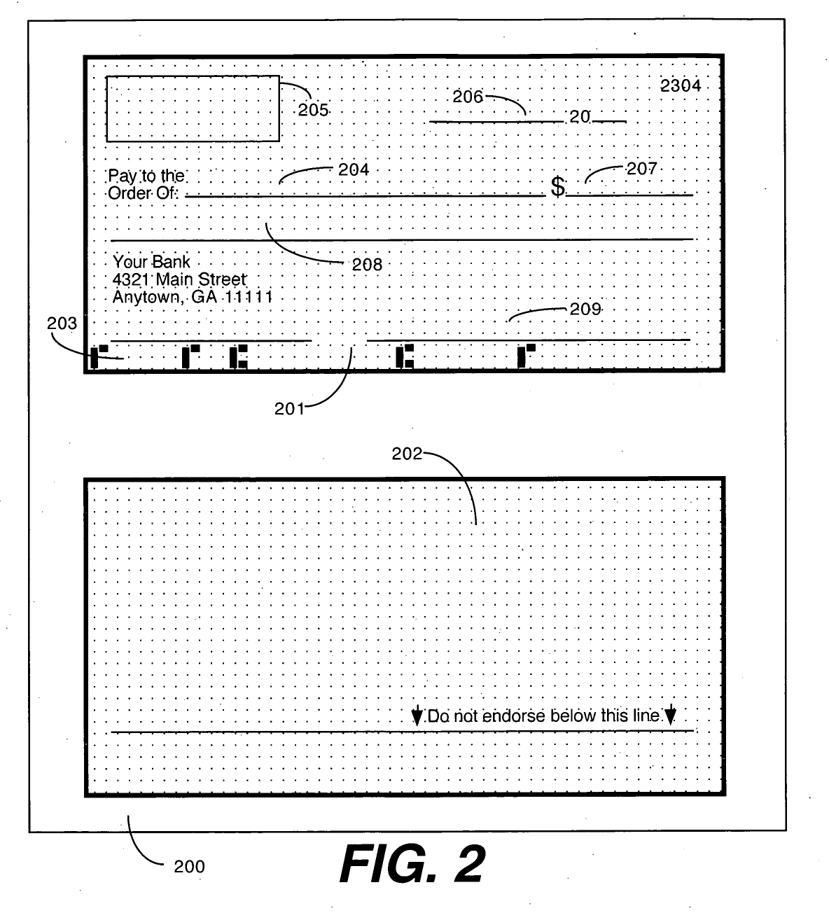

As noted, in one embodiment, the system generates an electronically created check file at step 111. Turning briefly to FIG. 2, illustrated therein is one embodiment of a blank electronically created check file 200. In this exemplary embodiment, the blank electronically created check file 200 is an electronic file, capable of being stored in a computer memory. The blank electronically created check file 200 includes at least a first image of the front 201 of a conventional check and at least a second image of the back 202 of a conventional check. Rather than being a scanned image of an original document, the blank electronically created check file 200 is a blank image that, when populated, becomes an electronically created check file.

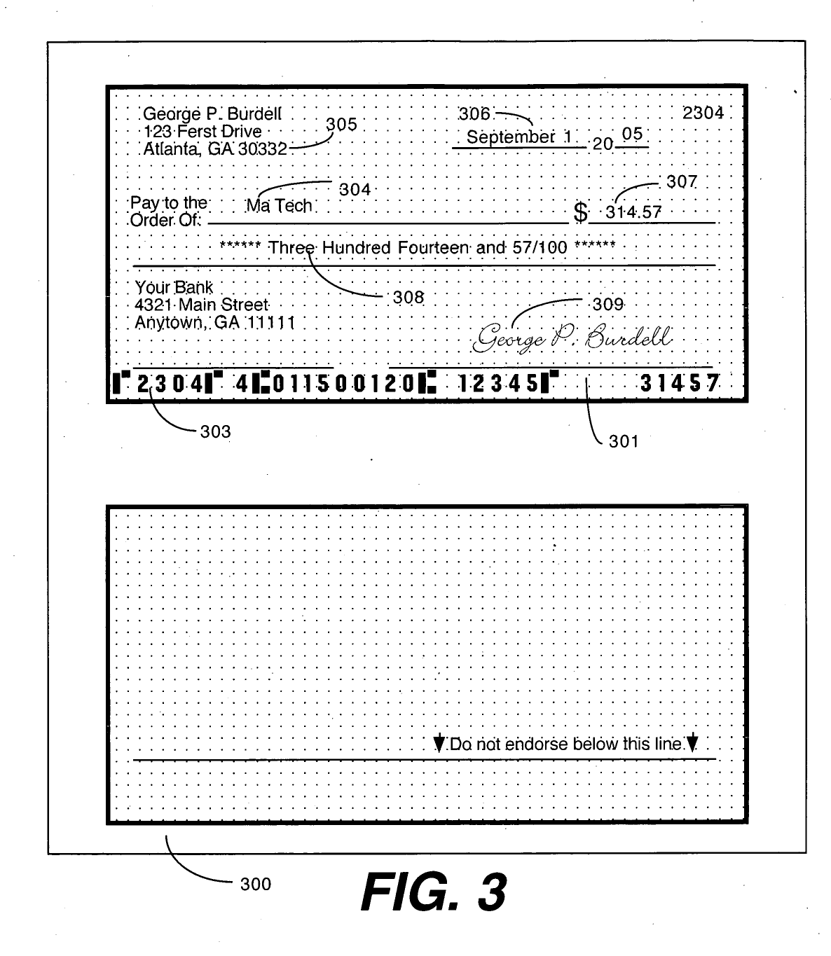

The blank electronically created check file 200 may include conventional information found on standard checks. For example, there may be spaces for the payor's information 205, the date the electronically created check file was created 206, to whom the electronically created check file will be directed 204, a spacing outline for a future virtual Magnetic Ink Character Recognition (MICR) line 203, spaces for the amount to be transferred 207,208 and a place where the payor would sign 209. The system may then take at least a subset of the data input received at step 107 and populate the blank electronically created check file 200. Such an electronically created check file is shown in FIG. 3.

Turning briefly to FIG. 3, note that the electronic file is now a true electronically created check file 300 suitable for posting to a customer's account. Thus, the electronically created check file 300 may stand alone as a negotiable instrument and is governed by traditional check law. The electronically created check file 300 may include payor information 305, payee information 304, the date upon which the electronic check presentment was created 306, the amount of the electronically created check file 307,308, the signature of the payor 309 and a virtual MICR line 303. Note that as this electronically created check file 300 is generated from an electronically created file, the signature of the payor 309 need not necessarily be a handwritten signature. During the creation of the electronically created check file, various forms of payor signature 300 may be populated in this field, including a digitized reproduction of the customer's signature, an e-signature equivalent, for example the words “authorization on file” or “authorization by telephone”, a conformal signature, for example represented by a “/s/”, and other equivalents obvious to those of ordinary skill in the art having the benefit of this disclosure.

The virtual MICR line 303 is effectively a string of numbers representing a conventional MICR line on the first image 301. The virtual MICR line 303 is suitable for printing a traditional MICR line on paper, and includes numbers identifying the bank upon which the electronic check presentment is drawn, the account at that bank, the amount of the electronically created check file and other information. In one embodiment, the generation of this virtual MICR line 303 may be in accordance with X9 industry standards as is known in the art.

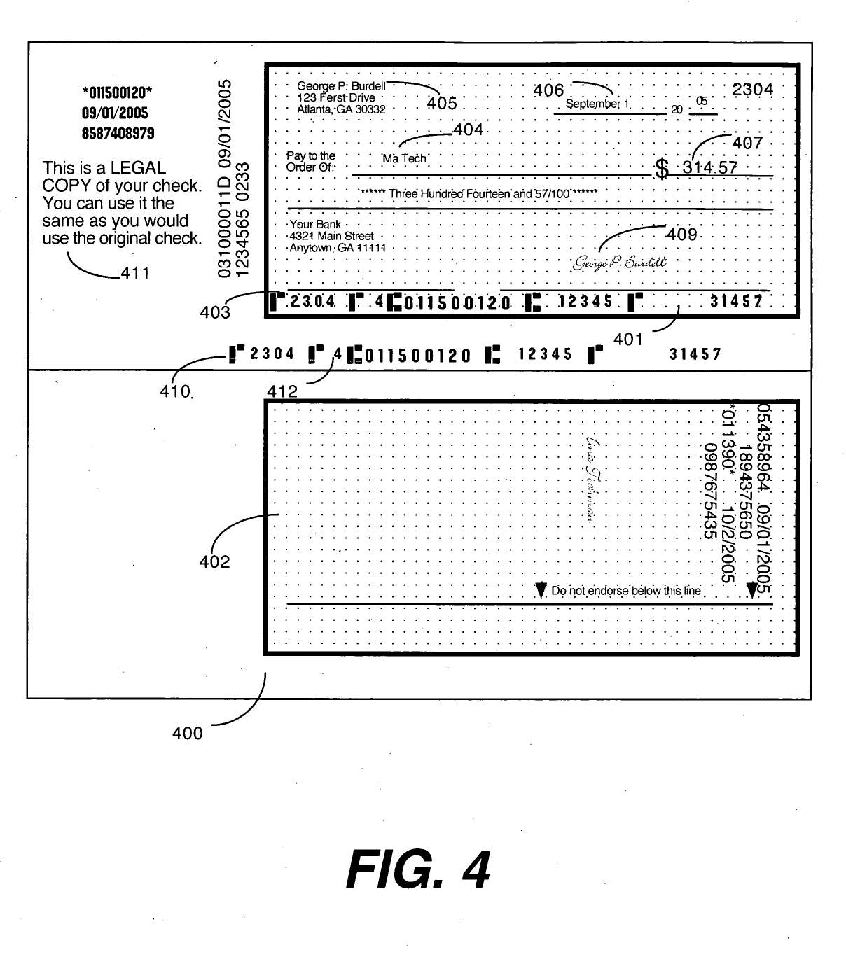

Turning now back to FIG. 1, in an alternate embodiment, the system generates both an electronically created check file and an electronically created negotiable instrument image file at step 111. Turning briefly to FIG. 4, illustrated therein is one embodiment of an electronically created negotiable instrument image file 400 in accordance with the invention. The term “electronically created” is employed because conventional substitute checks begin with an electronic scan of an original document. With the present invention, however, there is no need for an original document. As such, for clarity, the term electronically created is used. Once printed, however, the electronically created negotiable instrument image file 400 is just as much a substitute check as one that began by scanning.

The electronically created negotiable instrument image file 400 is similar to the electronically created check file (FIG. 3) in that it includes at least a first image of a check 401 and at least a second image of a check 402, which may be the front and back, respectively. The electronically created negotiable instrument image file also may include payor information 405, payee information 404, the date 406, amount 407,408 and a virtual signature 409. The electronically created negotiable instrument image file 400 further includes the virtual MICR line 403, with a string of numbers representing a true MICR line. The virtual MICR line 403, in one embodiment, is disposed on the first image 401.

The electronically created negotiable instrument image file 400 also includes additional components not found on the electronically created check file. In one embodiment, the electronically created negotiable instrument image file 400 includes suitable compliance language attached to the image. One example of suitable compliance language is a textual message comprising at least a lingual translation of the words “This is a legal copy of your check” and “You can use it the same way that you would use the original check” 411. The term “lingual translation” is used because in the embodiment of FIG. 4, the translation is in English. It will be clear to those of ordinary skill in the art having the benefit of this disclosure, however, that the invention is not so limited. These words, or a translation thereof, could appear in any number of languages, symbols or other communicative representations.

A second example of suitable compliance language, which differentiates the electronically created negotiable instrument image file 400 and the electronically created check file (FIG. 3) is the addition of and external processing code comprising the number “4” 412 in the virtual MICR line 403. In one embodiment, this number 412 is placed in Position 44, just before the ABA routing number, of the virtual MICR line 403. On an original check, this Position 44 is generally left blank.

One additional difference is that the virtual MICR line 403 may be reproduced as a second virtual MICR line 410 below the first image 401. This reproduction may occur in a slightly larger font size. Both MICR lines are preferably displayed in a MICR E-13 B or CMC-7 font, as is known in the art. It will be clear to those of ordinary skill in the art having the benefit of this disclosure that an electronically created negotiable instrument image file may be generated from the electronically created check file with additional information. The electronically created negotiable instrument image file, in one embodiment, may be printed for non-electronic record keeping. When the electronically created negotiable instrument image file is printed, it becomes a substitute check. Further, it is clear that the electronically created check file and electronically created negotiable instrument image file need not be created simultaneously. For example, the electronically created check file may be created first, while a paper substitute check may be created at a later date from the electronically created check file.

Turning now back to FIG. 1, once the electronic instrument, either an electronically created check file or both an electronically created check file and electronically created negotiable instrument image file, is created at step 111, that instrument is delivered for forward collection at step 112. Forward collection is simply the transfer of the instrument, either directly or through intermediaries, to a paying bank for payment. Since the delivery, or presentment, may occur with intermediaries, the step of delivering the electronically created check file 112 for forward collection may include delivering the electronically created check file to an entity selected from the group consisting of merchants 113, banks of first deposit 114, paying banks 115, indemnifying banks 116 or individuals 117.

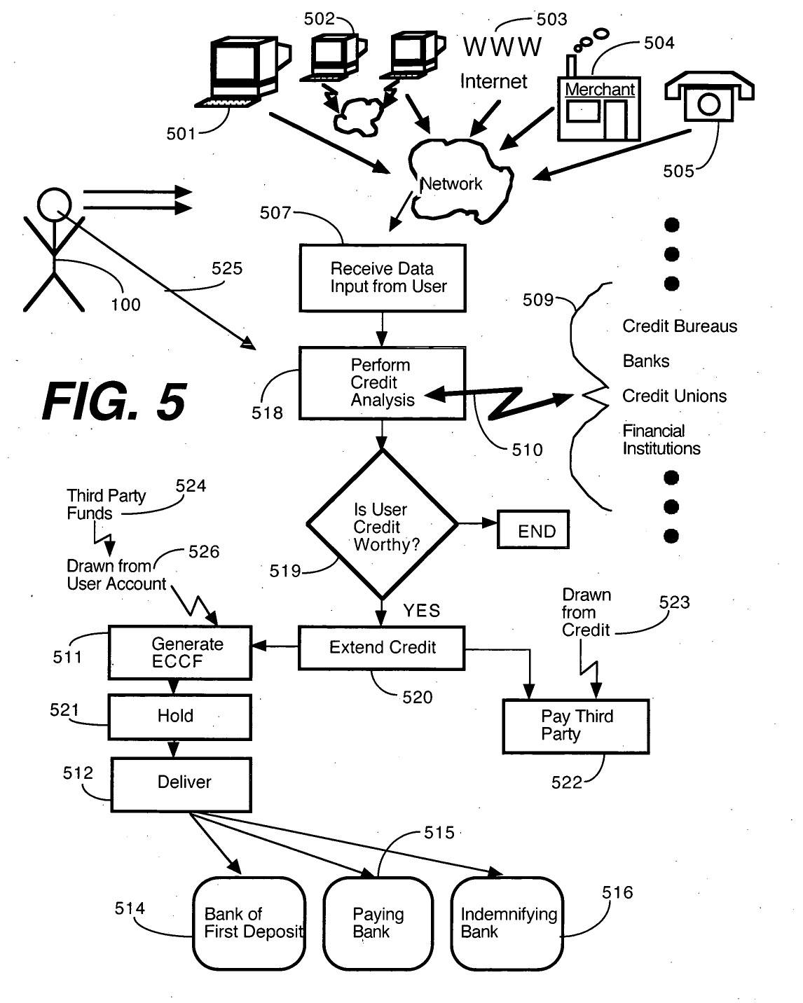

Turning now to FIG. 5, illustrated therein is an alternate embodiment of a method for accomplishing a paperless transfer of monetary funds in accordance with the invention. The embodiment of FIG. 5 differs from that of FIG. 1, in that it includes a temporary extension of credit in conjunction with the electronic fund transfer.

As with FIG. 1, the system receives data input from a user 100 at step 507. The step of receiving data input 507 may include receiving data from the user 100 from a source selected from the group consisting of oral communications 525, computers 501, computer networks 502, the Internet or World Wide Web 503, merchants 504 and telephone communications 505. It may occur through another network 506.

Since the embodiment of FIG. 5 involves the extension of credit, the system performs a credit analysis at step 518. In this credit analysis, the system determines whether the user is credit worthy based upon at least a subset of the data received from the user at step 507. For example, the system may inquire through electronic communications 510 with financial institutions and database services whether the user has a job and has made is five most recent bill payments. The system then judges whether the risk of default is below a predetermined threshold at decision 519. Where the user is credit worthy, a predetermined amount of credit is extended to the user at step 520. A subset of suitable information may include information like the user's bank's ABA routing number, the customer's account number, the amount to be withdrawn, and the date of withdrawal.

At step 522, a financial transaction to a first party is initiated. This may be generation of an item selected from the group consisting of paper checks, electronically created check files, substitute checks or combinations thereof. In any case, the item represents a claim to funds to be drawn from the predetermined amount of credit 523 extended to the user 100. The item is presented to a third party which may be an entity selected from the group consisting of creditors of the user, merchants, banks of first deposit, and others.

Concurrently with the initiation of the financial transaction to the first party, the extender of credit must also make provisions for repayment. This is accomplished by generating an electronically created check file payable to the extender of credit at step 511. Note that as with FIG. 1, a substitute check may be concurrently generated and presented for forward collection or held for record keeping.

This electronically created check file, which may include at least a first image of a check and a second image of a check, as well as a string of numbers representing a MICR line on the first image, represents funds to be drawn from an account belonging to the user 526. In one embodiment, since the creditor takes a risk by extending credit, this electronically created check file represents a claim to funds in the user's account as agreed upon by the lender and borrower. For example, one agreed upon amount may be in the amount of the predetermined amount of credit plus an additional charge.

Since credit is being extended, it is presumed that the user 100 did not have enough money in his account to cover the transaction, and thus the need for credit. However, if the user 100 is employed, the user may be willing to pay the credit and interest back when, for example, he receives his paycheck. As such, in one embodiment, the electronically created check file generated at step 511 is held for a predetermined period time or period at step 521. This predetermined time may be contingent upon a third party deposit 524 being credited to the account 526 belonging to the user. One example of a third party deposit would be a direct-deposit of wages by an employer.

When the holding period has expired, the electronically created check file generated at step 511 is presented for forward collection. It may be presented to an entity selected from the group consisting of banks of first deposit, paying banks, indemnifying banks, and others. As such, the extender of credit is dutifully repaid.

In the foregoing specification, specific embodiments of the present invention have been described. However, one of ordinary skill in the art appreciates that various modifications and changes can be made without departing from the scope of the present invention as set forth in the claims below. Thus, while preferred embodiments of the invention have been illustrated and described, it is clear that the invention is not so limited. Numerous modifications, changes, variations, substitutions, and equivalents will occur to those skilled in the art without departing from the spirit and scope of the present invention as defined by the following claims.

Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

What is claimed is:

1. A method for generating an electronic negotiable instrument, the method comprising the steps of:
a. receiving input from a user;
b. verifying that a one time consent exists on file;
c. generating an electronically created check file; and
d. delivering the electronic instrument for forward collection.

2. The method of claim 1, wherein the electronically created check file comprises:
a. at least a first image of a check and at least a second image of a check; and
b. a string of numbers representing a MICR line on the at least a first image, wherein the string of numbers identify at least a bank upon which the electronically created check file is drawn, an account at the at least a bank upon which the electronically created check file is drawn, and an amount of the electronically created check file.

3. The method of claim 2, further comprising the steps of:
a. generating an electronically created negotiable instrument image file, the electronically created negotiable instrument image file comprising:
i. the at least a first image of a check and the at least a second image of a check;
ii. a MICR line comprising the string of numbers representing a MICR line on the at least a first image; and
iii. suitable compliance language; and
b. presenting the electronically created negotiable instrument image file for forward collection.

4. The method of claim 2, wherein the step of receiving data from a user comprises receiving data from the user from a source selected from the group consisting of oral communications, computers, computer networks, the Internet, the World Wide Web, merchants, and telephone communications.

5. The method of claim 4, wherein the step of delivering the electronically created check file for forward collection comprises delivering the electronically created check file to an entity selected from the group consisting of merchants, banks of first deposit, paying banks and indemnifying banks.

6. A method for generating an electronic negotiable instrument, the method comprising the steps of:
a. receiving input from a user;
b. performing a credit analysis on the user;
c. extending the user a predetermined amount of credit;
d. initiating a financial transaction to a first party;
e. generating an electronically created check file;
f. holding the electronically created check file for a predetermined time; and
g. presenting the electronically created check file to an entity selected from the group consisting of banks of first deposit, paying banks and indemnifying banks.

7. The method of claim 6, wherein the step of receiving input from a user comprises receiving data from the user from a source selected from the group consisting of oral communications, computers, computer networks, the Internet, the World Wide Web, merchants, and telephone communications.

8. The method of claim 7, wherein the step of initiating a financial transaction to a first party comprises generating an item selected from the group consisting of electronically created check files and substitute checks, wherein the item represents a claim to funds to be drawn from the predetermined amount of credit.

9. The method of claim 8, wherein the predetermined time depends upon a third party depositing funds into an account of the user upon which the electronically created check file will be drawn.

10. The method of claim 9, wherein the electronically created check file represents a claim to funds in an amount as agreed by a lender and a borrower

11. The method of claim 10, wherein the amount as agreed by the lender and the borrower comprises the predetermined amount of credit plus an additional charge.

12. The method of claim 9, wherein the input from the user is selected from the group consisting of an ABA bank routing number, a bank account number, a bank name, an amount to be withdrawn, a next check number, a name, an address, a social security number, and a date.

13. A paperless method for generating a negotiable instrument, the method comprising the steps of:
a. receiving data from a user;
b. determining whether the user is credit worthy based upon at least a subset of the data from the user;
c. where the user is credit worthy, extending a predetermined amount of credit to the user;
d. generating a first electronically created check file;
e. presenting the first electronically created check file to an entity;
f. holding the second electronically created check file for a holding period; and
g. when the holding period has expired, presenting the second electronically created check file for forward collection.

14. The method of 13, wherein the first electronically created check file represents funds to be drawn from the predetermined amount of credit, further wherein the second electronically created check file represents funds to be drawn from an account belonging to the user.

15. The method of 14, wherein expiration of the holding period is contingent upon a third party deposit being credited to the account belonging to the user.

16. The method of 15, wherein the step of receiving data from a user comprises receiving data from the user from a source selected from the group consisting of oral communications, computers, computer networks, the Internet, the World Wide Web, merchants, and telephone communications.

17. The method of 16, wherein both the first electronically created check file and the second electronically created check file comprise:
a. at least a first image of a check and at least a second image ofa check; and
b. a string of numbers representing a MICR line on the at least a first image, wherein the string of numbers identify at least a bank upon which the electronically created check file is drawn, an account a the at least a bank upon which the electronically created check file is drawn, and an amount of the electronically created check file.

18. The method of claim 17, further comprising the steps of:
a. generating a substitute check comprising:
i. the at least a first image of a check and the at least a second image of a check;
ii. a MICR line comprising the string of numbers representing a MICR line on the at least a first image; and
iii. suitable compliance language; and
b. presenting the substitute check for forward collection.

19. The method of claim 18, wherein the data from the user is selected from the group consisting of an ABA bank routing number, a bank account number, a bank name, an amount to be withdrawn, a next check number, a name, an address, a social security number, and a date.

20. The method of claim 19, wherein the subset of the data comprises user's bank's ABA routing number, the customer's account number, the amount to be withdrawn, and the date of withdrawal.
